(19) United States
(12) Patent Application Publication
(10) Pub. No.: US 2003/0228407 A1
(43) Pub. Date: Dec. 11, 2003

(54) System for extracting constituents from an extraction

(76) Inventor: Andreas Buttner, Bad Kreuznach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/454,922

(22) Filed: Jun. 5, 2003

(30) Foreign Application Priority Data
Jun. 5, 2002 (DE) 10225079.0-43

(51) Int. Cl. A23L 2/00

(52) U.S. Cl. 426/599

(57) ABSTRACT

In a method for the extraction of constituents from an extractive, especially from comminuted vegetable material, with a liquid solvent, the solvent flows under pressure through at least one extraction reactor (3) with the extractive. The solvent flows through the extraction reactor (3) with abrupt changes of pressure.

The invention is relative to a method for the extraction of constituents from an extractive, especially from comminuted vegetable material, with a liquid solvent that flows under pressure through at least one extraction reactor with the extractive and is relative to a device for this purpose.

DE 31 23 588 C2 teaches a device for continuous extraction by dissolution under pressure. The device comprises a pressure screw, supported in a housing, for the transport of compressible, solid material from a solid-material inlet to a solid-material outlet and comprises a feed piece on the solid-material inlet that is arranged perpendicularly to the housing of the pressure screw. The pressure screw and the housing have a conical shape whose larger diameter is located at the solid-material inlet and whose smaller diameter is located at the solid-material outlet. The solid and the solution move in opposite directions. The rotation of the pressure screw increasingly raises the pressure on the solid, consequently the exchange of materials becomes more difficult and the yield of valuable products is reduced.

The invention has the problem of creating a method and a device of the initially cited type that assure a high yield of valuable products.

The invention solves this problem in a method for the extraction of constituents from an extractive, especially from comminuted vegetable material, with a liquid solvent that flows under pressure through an extraction reactor with the extractive in that the solvent flows through the extraction reactor with abrupt changes of pressure.

The abrupt changes in pressure of the solvent during the continuous extraction that have an effect in the entire hydraulic system and thus also in the extraction reactor bring about a rearrangement and a substance-dependent opening of the pores of the extractive in the extraction reactor. This dynamic convection method of extraction assures a relatively high yield of valuable products with a low cost for the apparatus. The pressure range under which the extraction takes place extends, in the sense of the invention, e.g., from a vacuum to a system pressure that is elevated relative to normal.

According to an advantageous embodiment of the invention the solvent flows through the extraction reactor under a change in the direction of pressure. This change in the direction of pressure of the solvent brings about an additional rearrangement of the extractive and therewith an additional intensification of the exchange of materials.

For an intimate penetration and flowthrough of the extractive the solvent is preferably conducted through a central distributor tube within the extraction reactor. The solvent is advantageously temperature controlled.

In order to assure an exclusive filling of the extraction reactor with the extractive and the solvent, a gas present in the extraction reactor is advantageously discharged via a vent valve. The gas is conducted into a solvent container.

In order that the solvent charged with a valuable product is recovered from tapers and pores of the extractive before the removal of the extractive from the extraction reactor, a vacuum is preferably produced in the extraction reactor during a drying of the extractive. The vacuum produced corresponds, e.g., to the vapor pressure of the solvent.

The gas preferably flows out of the solvent container into the extraction reactor before an emptying of the extraction reactor. The solvent still present in the system and charged with valuable product is transported into the solvent container by the inflow of the gas, e.g., air, into the extraction reactor.

In order to bring about the penetration of the extractive with the solvent in the extraction reactor and a rearrangement of the extractive by changing the pressure or the direction of pressure, the extractive is placed into at least one strainer basket in the extraction reactor.

According to the invention the problem is solved in a device for extracting constituents from an extractive, especially from comminuted vegetable material, with a liquid solvent in a solvent container connected in a circuit to at least one extraction reactor with the extractive in that a pressure-regulating valve for regulating the pressure of the solvent and a cutoff valve are placed in the circuit. The cutoff valve is arranged in such a manner that an abrupt drop in the pressure of the solvent is produced in the extraction reactor when this cutoff valve is opened.

These measures assure a rearrangement of the extractive by raising the pressure of the solvent with the pressure-regulating valve and by the abrupt drop in the pressure of the solvent in the extraction reactor and therefore also in the rest of the system, assuring a relatively high yield of valuable product. Of course, electronic control of the pressure-regulating valve as well as of the cutoff valve is possible in order to automate the continuous extraction process.

The pressure-regulating valve and the cutoff valve are advantageously placed in a return of the circuit. The cutoff valve is preferably arranged in a bypass line with respect to the pressure-regulating valve. Thus, it is not necessary to change the setting of the pressure-regulating valve upon an abrupt pressure drop of the solvent in the system.

In order to maintain the solvent at a temperature required for the extraction the circuit comprises a heat exchanger for temperature control of the solvent. The heat exchanger is assigned, e.g., to the initial feed path of the circuit.

A pump is advantageously arranged between the solvent container and the heat exchanger in order to transport the solvent in the circuit.

In order to produce a reversal of the direction of pressure in the system and in particular in the extraction container for rearranging the extractive, the direction of delivery of the pump can preferably be reversed.

In order that only the extractive and the solvent are present in the extraction reactor during the extraction, the extraction reactor is advantageously provided in its upper area with a vent valve coupled via a line to the solvent container. Gases and vapors that are in the system before the extraction or that are produced during the extraction are conducted out of the extraction reactor and flow into the solvent container.

The solvent container preferably comprises an exhaust line connected via a valve to the return. Gases present in the solvent container can flow via the exhaust line. When the valve is opened, the gases flow out of the solvent container into the circuit and wash the solvent containing active substances out of the extraction container into the solvent container, a so-called receiver container.

In order to draw remnants of the solvent provided with active substances from the extraction out of the extraction container, a cutoff valve is placed preferably in the return, the closing of which valve produces a vacuum in the extraction reactor, given the appropriate direction of delivery of the pump. The vacuum corresponds, e.g., to the vapor pressure of the solvent.

For an intimate flowthrough of the extractive with the solvent and to assure a rearrangement of the extractive upon the abrupt pressure drop or change of direction of pressure of the solvent, at least one strainer basket for receiving the extractive is placed with advantage in the extraction reactor. In addition thereto, the extractive can be readily removed out of the extraction reactor through the strainer basket provided with mesh on its circumference and its bottom.

A vertical distributor tube for the solvent is advantageously arranged in the center of the extraction reactor and communicates with the initial feed path. The solvent passes via the distributor tube through the mesh of strainer baskets directly onto the extractive.

Of course, the features previously cited and to be explained in the following can be used not only in the particular combination indicated but also in other combinations. The scope of the present invention is defined solely by the claims.

The invention is explained in detail in the following with an embodiment and with reference made to the associated drawings.

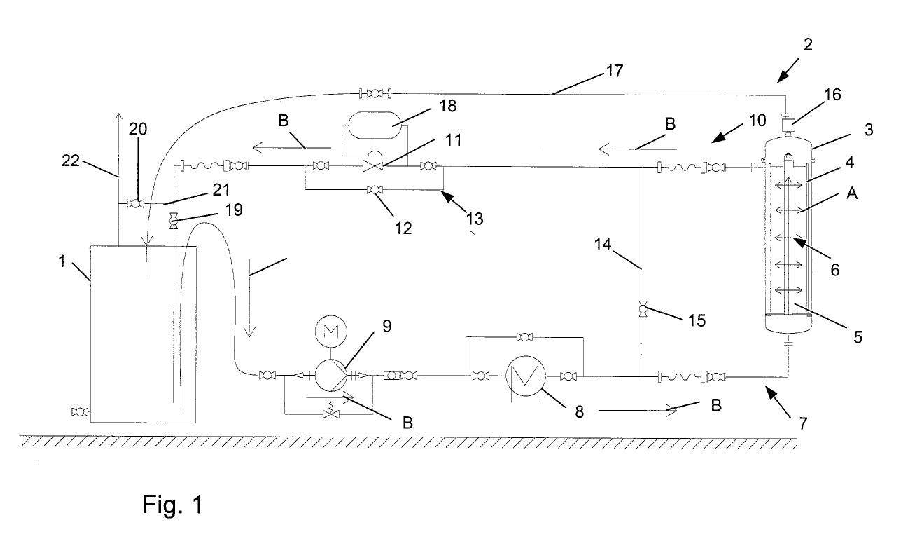

FIG. 1 shows a schematic view of a device in accordance with the invention during the method step of an extraction.

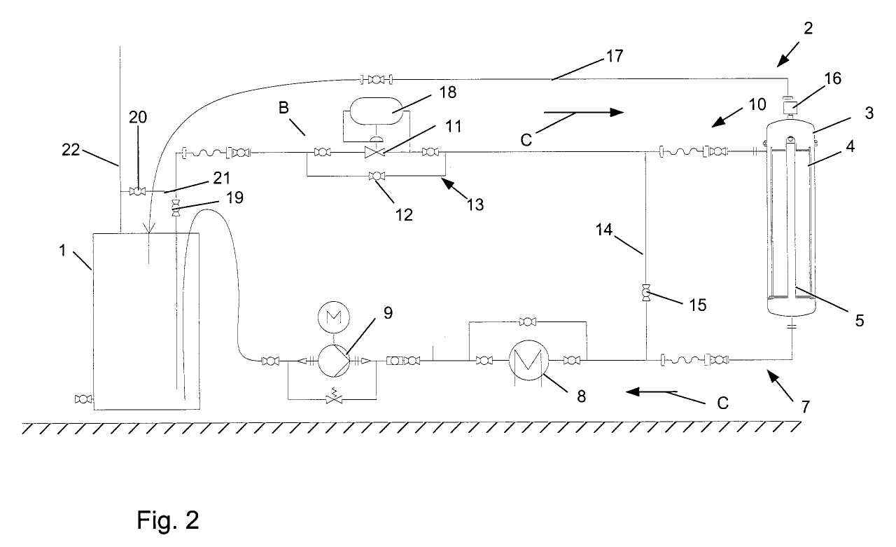

FIG. 2 shows a schematic view of the device according to FIG. 1 during the method step of a backwash.

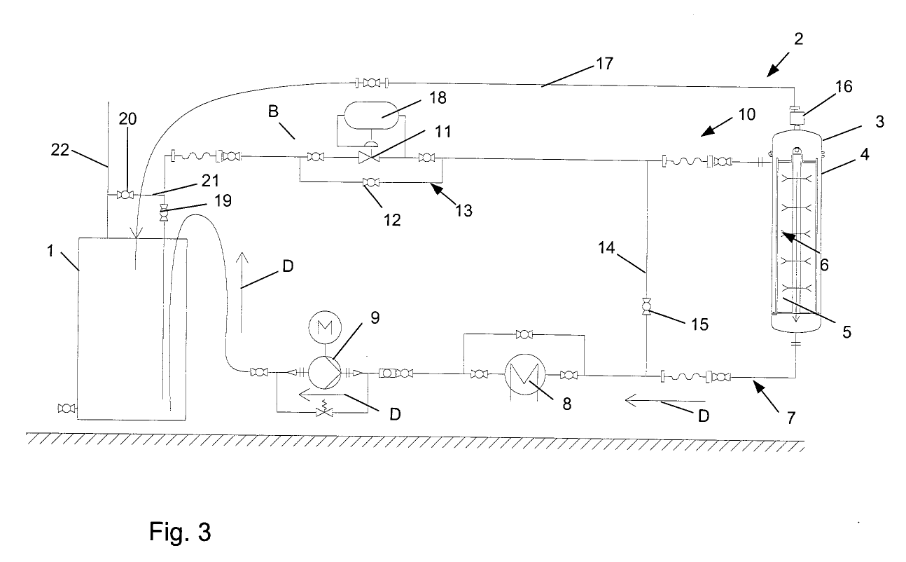

FIG. 3 shows a schematic view of the device according to FIG. 1 during the method steps of an evacuation and emptying.

The device comprises solvent container 1 that is substantially filled with a solvent and is connected in circuit 2 to extraction reactor 3. Several strainer baskets 4 with the extractive, namely, comminuted vegetable material, are placed into extraction reactor 3. Furthermore, vertically aligned distributor tube 5 extends into the center of extraction reactor 3, which tube is provided with radial bores 6 for the exiting of the solvent in accordance with double arrows A and communicates with initial feed path 7 of circuit 2.

Heat exchanger 8 with upstream pump 9 is placed in initial feed path 7 wherein pump 9 draws the solvent out of solvent container 1 and delivers it into extraction reactor 3. Pressure-regulating valve 11 for regulating the pressure of the solvent in the system and cutoff valve 12 are located in return 10 of circuit 2 which return runs into solvent container 1. Cutoff valve 12 is arranged in bypass line 13 in parallel with pressure-regulating valve 11. Initial feed path 7 communicates with return 10 via connecting line 14 with inserted cutoff valve 15.

During the extraction the solvent is pumped in the direction of arrows B from pump 9 via heat exchanger 8 and distributor tube 5 into extraction reactor 3. Initially, vent valve 16 associated with extraction reactor 3 is open, so that gasses and vapors present in extraction reactor 3 flow via line 17 into solvent container 1 and only the extractive and the solvent are present in extraction container 3. The solvent flows out of bores 6 of distributor tube 5 and penetrates the extractive received into strainer baskets 4, during which valuable products present in the extractive are dissolved and transported with the solvent in the direction of arrows B to solvent container 1. An appropriate adjustment of pressure-regulating valve 11 connected to controller 18 brings about a flowthrough through circuit 2 with a certain, relatively high hydrostatic pressure of the solvent. During the extraction cutoff valve 12 is opened at certain time intervals in order to produce an abrupt pressure drop in the system and the solvent passes via bypass line 13 into solvent container 1. The extractive is the rearranged in the extraction reactor thereby, and has a substance-dependent opening of pores as a consequence. Furthermore, new exchange and reaction surfaces are made available to the solvent by the extractive rearranged in strainer baskets 4, whereby a high yield of valuable products results.

During a backwash of the solvent the direction of delivery of pump 9 is reversed and cutoff valve 12 is opened on account of the direction-dependent flowthrough of pressure-regulating valve 11 so that the solvent flows through circuit 2 in the direction of arrows C. A rearrangement of the extractive also takes place in extraction reactor 3 during the backwash. During the backwash cutoff valve 19 placed in return 10 and connected immediately downstream of solvent container 1 is closed. A vacuum is produced in circuit 2 with the closing of cutoff valve 19 that brings about a recuperation of solvent charged with valuable products out of tapers and pores of the extractive. In addition, a drying of the extractive takes place.

Valve 20 is opened before the emptying of extraction reactor 3 or during the evacuating of the system, which valve is placed in line 21 connecting exhaust line 22 of solvent container 1 to return 10. When valve 20 is opened, gases flow through return 10 into extraction reactor 3 and the solvent still present is transported according to arrows D into solvent container 1.

Of course, additional extraction containers can be connected to circuit 2 for further extraction stages.

1. A method for the extraction of constituents from an extractive, especially from comminuted vegetable material, with a liquid solvent that flows under pressure through at least one extraction reactor (3) with the extractive, characterized in that the solvent flows through the extraction reactor (3) with abrupt changes of pressure.

2. The method according to claim 1, characterized in that the solvent flows through the extraction reactor (3) under a change in the direction of pressure.

3. The method according to claim 1 or 2, characterized in that the solvent is conducted through a central distributor tube (5) inside the extraction reactor (3).

4. The method according to one of claims 1 to 3, characterized in that the solvent is temperature controlled.

5. The method according to one of claims 1 to 4, characterized in that a gas present in the extraction reactor (3) is discharged via a vent valve (16).

6. The method according to claim 5, characterized in that the gas is conducted into a solvent container (1).

7. The method according to one of claims 1 to 6, characterized in that a vacuum is produced in the extraction reactor (3) during a drying of the extractive.

8. The method according to one of claims 5 to 7, characterized in that the gas overflows out of the solvent container (1) into the extraction reactor (3) before an emptying of the extraction reactor (3).

9. The method according to one of claims 1 to 8, characterized in that the extractive is placed into at least one strainer basket (4) in the extraction reactor (3).

10. A device for the extraction of constituents from an extractive, especially from comminuted vegetable material, with a liquid solvent in a solvent container (1) that is combined in the circuit (2) with at least one extraction reactor (3) with the extractive, especially for carrying out the method according to claims 1 to 9, characterized in that a pressure-regulating valve (11) for regulating the pressure of the solvent and a cutoff valve (12) are placed in the circuit (2) and that the cutoff valve (12) is arranged in such a manner that an abrupt pressure drop of the solvent is produced in the extraction reactor (3) when this cutoff valve is opened.

11. The device according to claim 10, characterized in that the pressure-regulating valve (11) and the cutoff valve (12) are placed in a return (10) of the circuit (2).

12. The device according to claim 10 or 11, characterized in that the cutoff valve (12) is arranged in a bypass line (13) with respect to the pressure-regulating valve (11).

13. The device according to claim 10 or 11, characterized in that the circuit (2) comprises a heat exchanger (8) for temperature control of the solvent.

14. The device according to one of claims 10 to 13, characterized in that a pump (9) is arranged between the solvent container (1) and the heat exchanger (1).

15. The device according to claim 14, characterized in that the direction of delivery of the pump (9) can be reversed.

16. The device according to one of claims 10 to 15, characterized in that the extraction reactor (3) is provided in its upper area with a vent valve (16) coupled via a line (17) to the solvent container (1).

17. The device according to claim 16, characterized in that the solvent container (1) comprises an exhaust line (21) connected via a valve (20) to the return (10).

18. The device according to one of claims 10 to 17, characterized in that cutoff valve (19) is placed in the return (10) and that the closing of this valve brings about a vacuum in the extraction reactor (3) given the appropriate direction of delivery of the pump (9).

19. The device according to one of claims 10 to 18, characterized in that at least one strainer basket (4) for receiving the extractive is placed in the extraction reactor (3).

20. The device according to one of claims 10 to 19, characterized in that a vertical distributor tube (5) for the solvent is arranged in the center of the extraction reactor (3) and communicates with the initial feed path (7).
